(19) United States
(12) Patent Application Publication
(10) Pub. No.: US 2015/0066719 A1
(43) Pub. Date: Mar. 5, 2015

(54) Financial Account Authentication

(71) Applicant: Yodlee, Inc., Redwood City, CA (US)

(72) Inventors: Prashant Kumar Agrawal, Bangalore (IN); Narayanan Govindarajan, Bangalore (IN); Nivedita Ramesh, Bangalore (IN)

(73) Assignee: Yodlee, Inc., Redwood City, CA (US)

(21) Appl. No.: 14/015,130

(22) Filed: Aug. 30, 2013

(51) Int. Cl. G06Q 40/02

(52) U.S. Cl. CPC G06Q 40/02
USPC 705/35

(57) ABSTRACT

Methods, systems, and apparatus, including computer programs encoded on computer storage media, for account authentication. A method includes receiving, from a user device, a request to include financial data describing a financial account in an interface, the financial account being associated with a particular financial institution; obtaining login information for accessing the financial account; providing the login information to a server system associated with the financial institution; in response to providing the login information to the server system, receiving, from the server system, data identifying one or more challenge questions; obtaining, from the user device, the respective answers for the one or more challenge questions; and storing the one or more challenge questions and their respective answers for use in accessing and aggregating financial data describing the financial account.

### TECHNICAL FIELD

This specification relates to authenticating user accounts for account aggregation.

### BACKGROUND

As the Internet has grown in popularity, more users are turning to services provided over the Internet to help manage their finances. These services can be provided by financial institutions, such as banks or credit card companies, or by account aggregators who aggregate and present user-specific financial information from one or more financial institutions. Users typically use a user name and password to log-in to webpage(s) maintained by a financial institution or an account aggregator. From the webpage(s), the user can access online banking, electronic bill payment, account aggregation, and other online financial services. Online banking provides a user access to the user's financial information and also offers a number of services to a user. Users can, for example, view their statements online, including transaction details and cancelled checks, transfer balances online, and apply for loans online.

Users can also use electronic bill payment to pay bills online by transferring money from an account to a creditor through the Internet. Many financial institutions allow a user to pay all of the user's bills from their webpage(s). Users can also schedule payments to creditors from some financial institution webpages. Users can also authorize automatic payments to satisfy periodic financial obligations. A payment is made automatically when, for example, a biller charges a user account or debits a user account without direct user input (other than an initial authorization to make automatic payments). Account aggregation involves presenting financial information related to one or more accounts of a user in one place. Each account can be with a different financial institution. Account aggregation makes it easy for a user to quickly get a summary of the user's overall finances.

### SUMMARY

This specification describes technologies relating to authenticating user accounts for financial account aggregation. Financial account aggregation generally requires storing, in an aggregator server system, user login credentials for user financial accounts with various financial institutions. Using stored user login credentials, the aggregator server system can access and aggregate user financial data from respective financial accounts, for example, through a financial institution website. However, in some cases, financial institution websites may include more complex authentication mechanisms than require a user to perform steps in addition to providing login credentials. For example, multifactor authentication (MFA) verifies the identity of a user of a financial institution through one or more challenge questions.

One example challenge question includes presenting the user with one or more personal questions to which the user provides answers. If the provided answers match the answers that were previously provided by the user to the financial institution, then the user is authenticated. Depending on the financial institution, challenge questions can be presented to a user at each login or when the user attempts to login from a user device that is not recognized by the financial institution's server system. Such complex authentication mechanisms can make it more difficult for the aggregator server system to access and aggregate financial data from a user's financial account.

Thus, in some implementations, the aggregator server system is configured to learn, for each user, MFA-based challenge information as such challenge questions are encountered. For example, when aggregating financial data for a particular user's financial account for a financial institution, the aggregator server system can provide the user's login credentials to the financial institution's server system. In response, the financial institution's server system can present the aggregator server system with one or more challenge questions. If the aggregator server system has answers to the challenge questions that have previously been provided by the user, the aggregator server system can provide the answers to the financial institution's server system to gain access to the user's financial account.

However, if the aggregator server system does not have answers to the challenge questions, then the aggregator server system learns, e.g., screen scrapes, the challenge questions that are presented, and attempts to obtain answers to the challenge questions from the user. For example, if the aggregator server system is presented with a challenge question “What is your mother's maiden name?” and the aggregator server system does not have a previously provided answer to this challenge question, then the aggregator server system learns the challenge question presented, e.g., the question, and attempts to obtain an answer to the challenge question from the user.

In situations where the aggregator server system has gained access to a user's financial account on a financial server system, the aggregator server system accesses the user's profile webpage on the financial server system and obtains (e.g., screen scrapes) challenge questions and, if available, respective answers to the challenge questions that are associated with the user. If answers are not available for one or more challenge questions, then the aggregator server system stores data describing the one or more challenge questions and attempts to obtain respective answers to the one or more challenge questions from the user (e.g., by presenting an interface that requests answers the next time the user accesses the aggregator server system).

In some implementations, the aggregator server system learns, e.g., copies, data identifying a web cookie that was deployed by a financial institution's server system to a user device upon the user successfully logging into the financial institution's server system. This web cookie is used to identify the user device to the financial institution's server system on subsequent logins. Generally, user devices that are recognized by a financial institution's server system are not presented with challenge questions, and are permitted to access respective financial accounts upon successfully providing the user's username and password.

In general, one aspect of the subject matter described in this specification can be embodied in methods that include the actions of receiving, from a user device, a request to include financial data describing a financial account in an interface, the financial account being associated with a particular financial institution; obtaining login information for accessing the financial account; providing the login information to a server system associated with the financial institution; in response to providing the login information to the server system, receiving, from the server system, data identifying one or more challenge questions; obtaining, from the user device, the respective answers for the one or more challenge questions; and storing the one or more challenge questions and their respective answers for use in accessing and aggregating financial data describing the financial account. Other embodiments of this aspect include corresponding systems, apparatus, and computer programs recorded on computer storage devices, each configured to perform the operations of the methods.

These and other embodiments can each optionally include one or more of the following features. The method further includes providing the login information to a server system associated with the financial institution; in response to providing the login information to the server system, receiving, from the server system, data identifying the one or more challenge questions; providing, to the server system, the respective answers to the one or more challenge questions; in response to providing the respective answers, obtaining, from the financial institution, financial data describing the financial account; and aggregating the obtained financial data for use in describing the financial account in the interface. Obtaining, from the user device, the respective answers for the one or more challenge questions includes: presenting, to the user device, an interface that identifies the one or more challenge questions; and receiving, from the user device, respective answers to the one or more challenge questions.

Obtaining login information for accessing the financial account includes: presenting, to the user device, an interface requesting login credentials; and receiving, from the user device, the login credentials. The one or more challenge questions includes a request for entering a one-time password that was transmitted from the server system to the user device. The method further includes obtaining, from the aggregator server system, data identifying a web cookie, wherein the web cookie identifies the aggregator server system to the server system, and wherein the web cookie was provided to the aggregator server system from the server system upon providing the login information to the server system; and storing the data identifying the web cookie for use in accessing and aggregating financial data describing the financial account.

The method further includes providing, to the server system associated with the financial institution, the login information and the data identifying the web cookie; in response to providing the login information and the data identifying the web cookie, obtaining, from the financial institution, financial data describing the financial account; and aggregating the obtained financial data for use in describing the financial account in the interface. The challenge questions have respective answers that were previously provided to the server system by the user. At least one of the challenge questions have a respective answer that was generated by the server system, and wherein the respective answer was provided by the user using the user device through an interface provided by the aggregator server system.

Particular embodiments of the subject matter described in this specification can be implemented so as to realize one or more of the following advantages. An aggregation system can be configured to aggregate a user's financial data from financial institutions that implement multifactor authentication. The aggregator server system can incrementally learn new challenge question information as such information is encountered during the aggregation process. The aggregator server system can learn challenge questions when they are presented to the aggregator server system as part of the login process. The aggregator server system can also learn challenge questions by screen scraping challenge questions, e.g., questions, from webpages in the financial institution's server system. The aggregator server system can learn and deploy user-specific web cookies that are issued by financial institution server systems

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example aggregation system used to aggregate financial data.

FIG. 2 illustrates an example method for learning challenge question information.

FIG. 3 illustrates an example method for providing challenge question information.

FIG. 4 illustrates an example method for deploying stored web cookies.

FIG. 5 is a schematic diagram of an example of a generic computer system.

### DETAILED DESCRIPTION

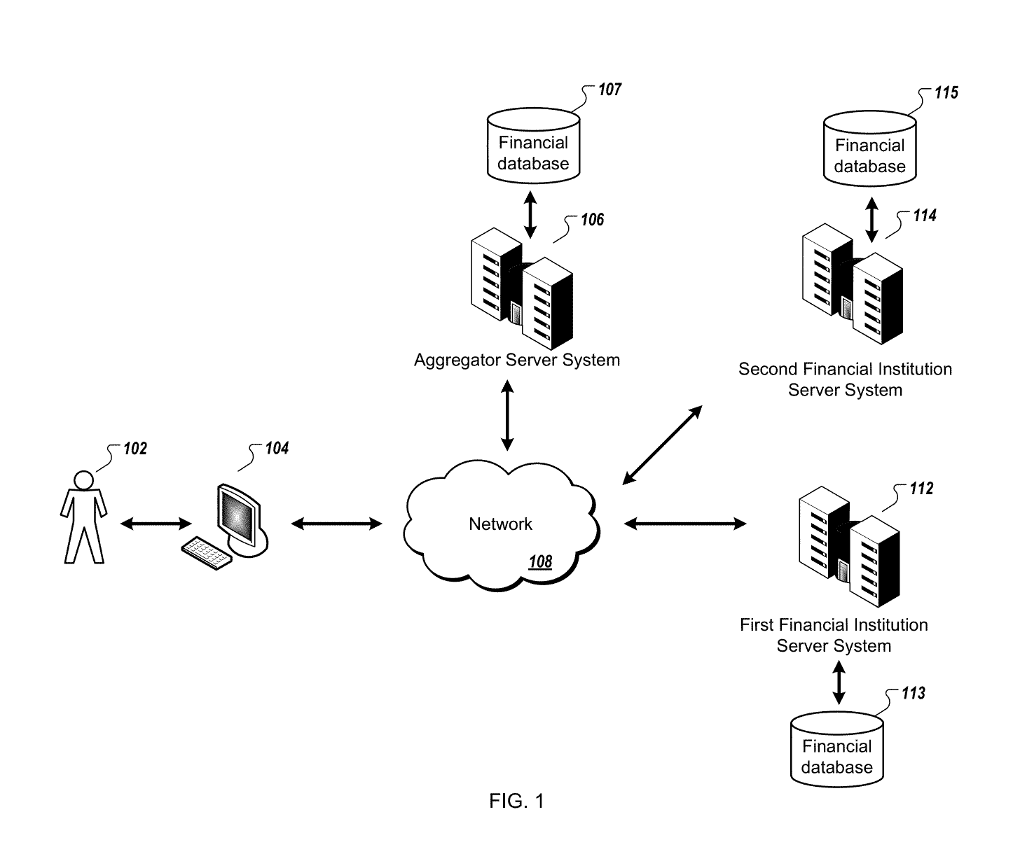

FIG. 1 illustrates an example aggregation system used to aggregate financial data. One or more user devices, e.g., the user device 104, an aggregator server system 106, and one or more financial institution server systems, e.g., the systems 112 and 114, are connected through a network 108. Each user device, the aggregator server system 106, and each financial institution server system can include one or more computing devices.

Each financial institution is an institution that provides financial services, deals in financial instruments, or lends, invests, or stores money. Examples of financial institutions include banks, brokerage firms, credit card companies, and credit unions. Each financial institution stores, for example, in a respective database that is associated with its respective server system, financial information about users that have a financial account with the respective financial institution. As shown in FIG. 1, for example, database 113 can communicate with the system 112 and database 115 can communicate with the system 114. The financial information can also be stored in a database, e.g., database 107, in communication with the aggregator server system 106 once a user has requested aggregation of their financial accounts on a financial institution server system, e.g., the system 112 or 114. A user can have an account with the financial institution when, for example, the user deposits money at the institution or has a line of credit provided by the financial institution.

Financial information, or financial data, includes, for example, customer data, account data, financial institution data, payee data, and transaction data. Customer data includes the customer's name and contact information, e.g., the customer's address, telephone number, and email address. Customer data can also include the customer's password or PIN. Account data includes the customer's account numbers, financial institutions, and account balances. The financial institution data includes the financial institution's name and address and the financial institution's ABA or routing number.

Users, e.g., the user 102, with respective accounts with one or more of the financial institutions can use one or more user devices, e.g., the user device 104, to access financial information related to their account with a financial institution. As described below, the users can access this information through an interface provided by the aggregator server system 106 or through an interface provided by a financial institution that includes data provided by the aggregator server system 106 as a backend provider.

Some examples of user devices include computers, tablets, and mobile devices, e.g., cellular phones. A user device can present a user interface through, for example, a computer program that presents data, e.g., text and images, in a format specified by the aggregator server system 106. In some implementations, the user interface is presented in a web browser. The web browser receives one or more webpages from the aggregator server 106 and presents the webpages to the user. Presenting the user interfaces to the user can include displaying the user interfaces on a computer monitor or other display device. Presenting the user interfaces can also include any other method of conveying information to the user, for example presenting sounds corresponding to the user interfaces or providing haptic feedback corresponding to the user interfaces.

The aggregator server system 106 runs applications that provide various services to users, including account aggregation, presentation of financial information, and automatic bill payments. The aggregator server system 106 can provide these services directly to a user either on its own behalf or on behalf of a financial institution. In situations where the aggregator server system 106 provides services directly to a user on behalf of a financial institution, it optionally brands communications it sends to the user's device 104 with the financial institution's logo, colors, or other information so that the user, viewing the communication on the user device 104, is given the impression that the user is interacting with the financial institution server 112 rather than the aggregator server system 106. In brief, the aggregator server system 106 can store data associating financial institutions with graphic images and color codes, e.g., in a database. When the aggregator server system 106 generates a user interface, e.g. a webpage, branded as a financial institution, the server 106 inserts the graphic images and color codes associated with the financial institution into the user interface that is then sent to the user, e.g., into a markup language document corresponding to a webpage.

Alternatively, the aggregator server system 106 can be configured as a backend provider and can provide software, support, and other tools to a financial institution to allow the financial institution to provide some or all these services to a user directly through, for example, the financial institution's website that is hosted on the financial institution's server system, e.g., the system 112. In some implementations, the aggregator server system 106 and a financial institution are the same entity, and the aggregator server system 106 and the financial institution server system 112 are the same system.

As used in this specification, account aggregation involves collecting financial information about a user. Data representing this information is optionally stored in a data repository, e.g., a database, on the aggregator server system 106, or on one or more financial institution server systems, e.g., the systems 112 and 114. Financial information can be collected in different ways. In some implementations, information is received directly from the system 112 or 114. In some implementations, the aggregator server system 106 runs one or more agents to extract user-specific financial information from various webpages and other consumer-accessible channels, for example public OFX feeds.

An agent is a computer program that extracts financial information by, for example, screen scraping by parsing the HTML code of webpages and identifying relevant information, or by extracting financial information from data feeds. A webpage is a block of data identified by a URL that is available on the Internet. One example of a webpage is a HyperText Markup Language (HTML) file. Webpages commonly contain content; however, webpages can also refer to content outside the webpage that is presented when the webpage loads in a user's web browser. Webpages can also generate content dynamically based on interactions with the user. A public OFX feed is a stream of financial data sent to another computer, for example, over the Internet, by a server of one or more financial institutions, where the data is formatted in accordance with the Open Financial Exchange standard. Other methods of gathering financial information are also envisioned.

When collecting financial information about a user 102 from a particular financial institution, the aggregator server system 106 typically logs into to the user's account on the financial institution's website using the user's login credentials, e.g., login and password, for the website. The process of how the aggregator server system 106 obtains a user's login credentials can vary depending on whether the aggregator server system 106 provides services directly to a user on its own behalf or on behalf of a financial institution, or as a backend provider.

For example, if the aggregator server system 106 is providing services on behalf of itself or on behalf of a financial institution, a user 102 accessing the aggregator server system 106 using a user device 104 interacts with an interface provided by the aggregator server system 106 to identify a financial institution and to login to the user's account for that financial institution. For example, the interface provided by the aggregator server system 106 can be a financial dashboard that presents financial information for the user's accounts on various financial institutions. The aggregator server system 106 can capture the user's login credentials and store them in a database, e.g., the database 107. The aggregator server system 106 can later use the stored login credentials to access and collect the user's financial information from the financial institution's website. This process can be repeated to configure the aggregator server system 106 to collect data from other financial institutions, e.g., the different financial institution server system 114, with which the user has accounts.

In another example, if the aggregator server system 106 is providing services to a particular financial institution as a backend provider, a user 102 using a user device 104 to access the particular financial institution's server system, e.g., the system 112, interacts with an interface provided by the particular financial institution to identify a different financial institution and to login to the user's account for the different financial institution. For example, the interface provided by the particular financial institution can be a financial dashboard that presents financial information for the user's accounts on various financial institutions. The user can identify a different financial institution, e.g., the system 114, with which the user has a financial account to be included in the financial dashboard.

In response to the user identifying the different financial institution, the interface can provide the user with a login interface for inputting login credentials for the user's account on the different financial institution. Once the user successfully inputs the user's login credentials, the aggregator server system 106 can capture the user's login credentials for the different financial institution and can store the login credentials in a database, e.g., the database 107. The aggregator server system 106 can later use the stored login credentials to access and collect the user's financial information from the different financial institution's website.

The financial institution systems, e.g., the systems 112 and 114, can be configured to authenticate users using multifactor authentication, as described above. In some implementations, the aggregator server system 106 is configured to learn, for each user, MFA-based challenge question information as such challenge questions are received. For example, when aggregating financial data in a particular user's financial account for a financial institution, the aggregator server system accesses the particular user's financial account by providing the user's login credentials to the financial institution's server system. In response to providing the user's login credentials, the financial institution's server system can present the aggregator server system with one or more challenge questions before permitting the aggregator server system access to the particular user's financial account.

In some implementations, if the aggregator server system has respective answers to the one or more challenge questions that were previously provided by the particular user, the aggregator server system can provide the respective answers to the financial institution's server system to gain access to the user's financial account. However, if the aggregator server system does not have respective answers to the one or more challenge questions, then the aggregator server system learns the one or more challenge questions that are presented by the financial institution's server system and attempts to obtain respective answers to the one or more challenge questions from the particular user. For example, the financial institution's server system can present the one or more challenge questions to the aggregator server system in a web interface. The aggregator server system can learn the one or more challenges by, for example, screen scraping data describing the challenge questions from the web interface and storing that data.

For example, if the aggregator server system is presented with a challenge question “What is your mother's maiden name?” and the aggregator server system does not have a previously provided answer to this challenge question, then the aggregator server system learns the challenge question presented, e.g., the question, and attempts to obtain an answer to the challenge question from the user. In some implementations, the aggregator server system presents data describing the learned challenge questions to the particular user in an interface. The particular user can then interact with the interface to provide respective answers to the challenge questions. Once the particular user provides the respective answers to the aggregator server system, the aggregator server system stores the respective answers for future use. Thus, for example, the next time the aggregator server system attempts to access the particular user's financial account, and the financial institution's server system challenge questions the aggregator server system using the same challenge questions, the aggregator server system can provide respective answers to the challenge questions without having to prompt the particular user.

In some implementations, once the aggregator server system obtains access to the particular user's financial account, the aggregator server system navigates to a webpage in the financial institution's website that includes data describing one or more challenge questions for the particular user. The aggregator server system can learn these one or more challenge questions by, for example, screen scraping the data in the webpage. In some implementations, the webpage includes data describing respective answers to the one or more challenge questions. In such implementations, the aggregator server system also learns the respective answers to the one or more challenge questions by, for example, screen scraping the data describing the respective answers that are presented in the webpage.

In some cases, when the particular user accessing a user device is configuring the aggregator server system for aggregating financial data from a particular financial institution's server system, the user uses the user device to interact with an interface provided by the aggregator server system to identify the particular financial institution and to login to the user's financial account for that particular financial institution. When logging into the particular financial institution's server system, the aggregator server system can select an option in the financial institution's website that requests that the financial institution's server system recognize the aggregator server system for future logins (e.g., “Is this your personal computer?”). In such cases, the financial institution's server system transmits a web cookie to the aggregator server system that is used to identify the aggregator server system to the financial institution's server system. The aggregator server system can store the web cookie, for example, in a database.

Typically, when the user interacting with the user device subsequently attempts to login to the financial institution's server system, the financial institution's server system recognizes the user device based on the web cookie that is stored on the aggregator server system. As a result of this identification, the financial institution's server system generally does not present any challenge questions to the user device and, instead, permits the user device to gain access to the user's financial account based solely on providing the user's login credentials. Similarly, when the user uses the user device to interact with the financial institution's server system through an interface on the aggregator server system, the financial institution's server system will recognize the aggregator server system based on the web cookie that is stored on the aggregator server system.

In some implementations, when the user is configuring the aggregator server system to aggregate financial data from a particular financial institution's server system, the aggregator server system obtains the user's login credentials for the particular financial institution's server system, as described above, and also obtains, from the user device, the web cookie that was provided by the particular financial institution's server system. In such implementations, when aggregating financial data from the user's financial account on the particular financial institution's server system, the aggregator server system provides the particular financial institution's server system with the user's login credentials and also deploys the captured web cookie. By deploying the web cookie, the aggregator server system is typically not presented with challenge questions and, as a result, the aggregator server system is able to obtain and aggregate the user's financial data from the financial institution's server system without having to provide answers to the challenge questions.

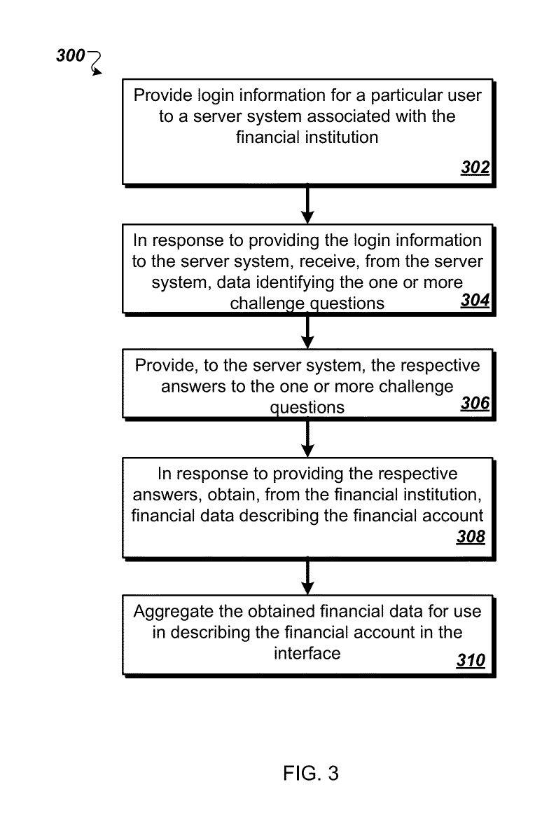

In some implementations, the aggregator server system learns, e.g., copies and saves in a database, data identifying a web cookie that was deployed by a financial institution's server system to the aggregator server system upon the successful logging into the financial institution's server system. This web cookie is used to identify the user device to the financial institution's server system on subsequent logins. Generally, devices (e.g., the user device or the aggregator server system) that are recognized by a financial institution's server system are not presented with challenge questions, and are permitted to access respective financial accounts upon successfully providing the user's username and password. Use of web cookies is described in more detail below in reference to FIG. 3.

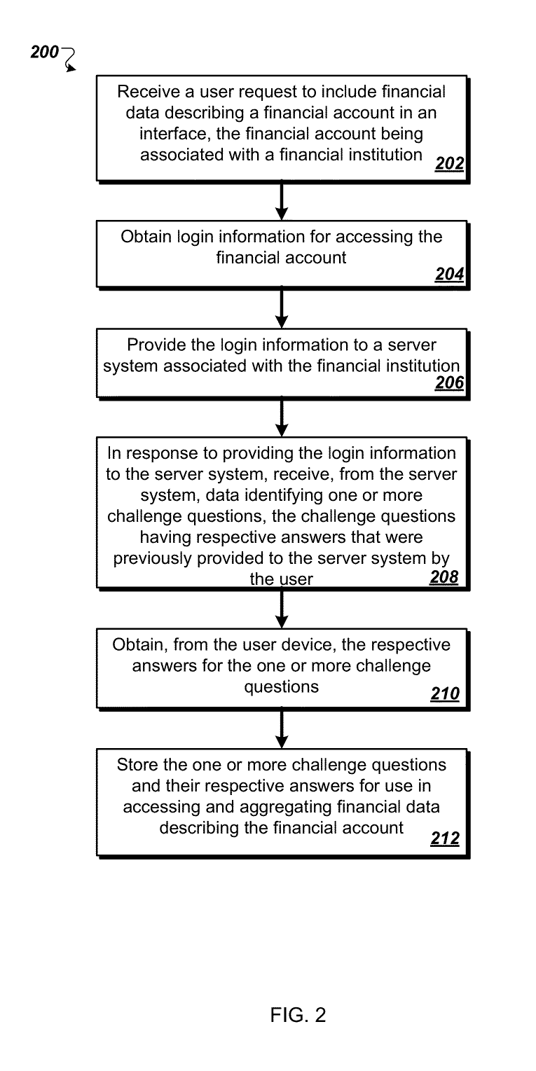

FIG. 2 illustrates an example method 200 for learning challenge question information. For convenience, the example method 200 will be described in reference to a system that performs the method 200. The system can be, for example, the aggregator server system 106, or the financial institution server system 112 or 114.

The system receives, from a user device, a request to include financial data describing a financial account in an interface, the financial account being associated with a particular financial institution (step 202). As described above, the user request can be received, for example, from a user operating a user device that is interacting with the system, e.g., the aggregator server system 106, or with a financial institution server system through a network.

The system obtains login information for accessing the financial account (step 204). For example, in some implementations, the system provides the user device with a login interface for inputting login credentials for the user's financial account. The aggregator server system captures and stores the user's login credentials once the user inputs the user's login credentials.

The system provides the login information to a server system associated with the financial institution (step 206). For example, the system can provide the login information to the financial institution's server system through a network, e.g., the network 108.

In response to providing the login information to the server system, the system receives, from the server system, data identifying one or more challenge questions, the challenge questions having respective answers that were previously provided to the server system by the user (step 208). As described above, the server system can provide the system with one or more challenge questions for which the user has previously provided respective answers. The challenge questions can include one or more personal questions for which only the user would typically have knowledge of (e.g., “What is your mother's maiden name?”, “What was the name of your first pet?”, and “In what city did you honeymoon?”).

In some implementations, the system also receives, from the server system, one or more web cookies. Generally, a web cookie (e.g., an HTTP cookie, cookie, browser cookie, or flash cookie, or a cookie stored in web local storage) is data that is sent from the server system to a user's web browser while a user is browsing a website. The data describing a web cookie can include one or more values including, for example, a name of the web cookie, a value of the cookie, a timestamp indicating when the web cookie expires, a Uniform Resource Locator (URL) path the web cookie is valid for, a domain name the web cookie is valid for, and whether a secure connection is needed to use the web cookie.

A flash cookie (e.g., local shared object) is typically used in websites that use Adobe Flash®. Flash cookies can also include data describing a name, value, expiration timestamp, a path the cookie is valid for, a domain the cookie is valid for, and whether a secure connection is needed to use the flash cookie. Unlike other web cookies, however, flash cookies are transmitted as file objects. Typically, when a user operating a user device logs into the server system in the future, the data stored in the one or more web cookies can be retrieved by the server system from the aggregator server system (e.g., from the database 107) for the user to identify the user.

In some implementations, the system stores the one or more web cookies that were transmitted by the server system. Each stored web cookie is associated with a particular user and a particular financial institution. The system stores flash cookies differently from other web cookies.

With respect to storing flash cookies, if a flash cookie for a particular user and a particular financial institution's server system is not already stored in the system, then the system stores the flash cookie in a cookie list (e.g., an XML file). If a flash cookie for a particular user and a particular financial institution's server system is already stored in the system, the system updates the existing flash cookie with the flash cookie that was received from the server system after determining a change in the existing flash cookie and the received flash cookie. Since flash cookies are file objects, the system reads and encodes the contents of the file objects and stores the encoded values in the cookie list.

With respect to storing web cookies, if a web cookie for a particular user and a particular financial institution's server system is not already stored in the system, then the system stores the web cookie in a cookie list. If a web cookie for a particular user and a particular financial institution's server system is already stored in the system, the system updates the existing web cookie with the web cookie that was received from the server system after determining a change in the existing web cookie and the received web cookie. For example, the system can update the web cookie when there is a change in a cookie value or a change in the expiration timestamp for the web cookie. The system can also delete web cookies from the cookie list when the web cookies have expired, as determined using the expiration timestamps associated with the web cookies.

The system obtains, from the user device, the respective answers for the one or more challenge questions (step 210). As described above, the system can obtain respective answers to the one or more challenge questions from the user by presenting the user device with an interface that displays the challenge questions and requests respective answers to the challenge questions. The user can interact with the user device to input the respective answers using the interface provided.

In some implementations, the challenge questions include a one-time password question. For example, the server system can generate a one-time password (OTP), e.g., a password that is valid for only one login session or transaction, and can transmit the OTP to the user device. Typically, if the user was logging into the server system from the user device, the user would provide the OTP to the server system to gain access to the user's financial account. However, when logging into the server system for aggregating the user's financial account, the system does not have knowledge of the OTP, and thus cannot gain access to the user's financial account. In situations where the system is presented with a OTP challenge question, the system provides the user device with an interface for inputting the OTP that was transmitted to the user device by the server system. Once the OTP has been inputted, the system provides the OTP to the server system and, accordingly, gains access to the user's financial account.

The system stores the one or more challenge questions and their respective answers for use in accessing and aggregating financial data describing the financial account (step 212). The system can store the one or more challenge questions and their respective answers in a database, e.g., the database 107, for future login attempts during which the server system requires the system to answer one or more of the challenge questions. Thus, for example, if during a future login attempt the server system asks the system a challenge question “What is your mother's maiden name?”, the system can retrieve the user's respective answer to the challenge question from the database without having to prompt the user for an answer to the challenge question.

For example, when storing learned questions and answers for the particular user, the system can create a database entry having multiple fields with first field identifying the particular user (e.g., using a user identifier), a second field to store data describing a question, and a third field to store data describing a corresponding answer to the question. When an answer to a question is needed for a particular user, the system access the database to identify a database entry that includes data describing the question for the particular user and retrieve data describing the answer in the database entry.

FIG. 3 illustrates an example method 300 for providing challenge question information. For convenience, the example method 300 will be described in reference to a system that performs the method 300. The system can be, for example, the aggregator server system 106, or the financial institution server system 112 or 114.

The system provides login information to a server system associated with a financial institution (step 302). As described above, when aggregating a user's financial account on a particular financial institution, the system can transmit the user's login credentials (e.g., username and password) to the particular financial institution's server system over a network, e.g., the network 108.

In response to providing the login information to the server system, the system receives, from the server system, data identifying the one or more challenge questions (step 304).

The system provides, to the server system, the respective answers to the one or more challenge questions (step 306). In situations where the system has already obtained, from the user, respective answers to the one or more challenge questions, the system can retrieve the respective answers from a database, e.g., the database 108, and can provide the respective answers to the server system. In situations where the system has not obtained, from the user, respective answers to one or more challenge questions, the system can obtain respective answers to the one or more challenge questions from the user, as described above.

In response to providing the respective answers, the system obtains, from the particular financial institution, financial data describing the financial account (step 308). Thus, by providing answers to the challenge questions, the system can obtain access to the user's financial account on the particular financial institution.

The system aggregates the obtained financial data for use in describing the financial account in an interface (step 310).

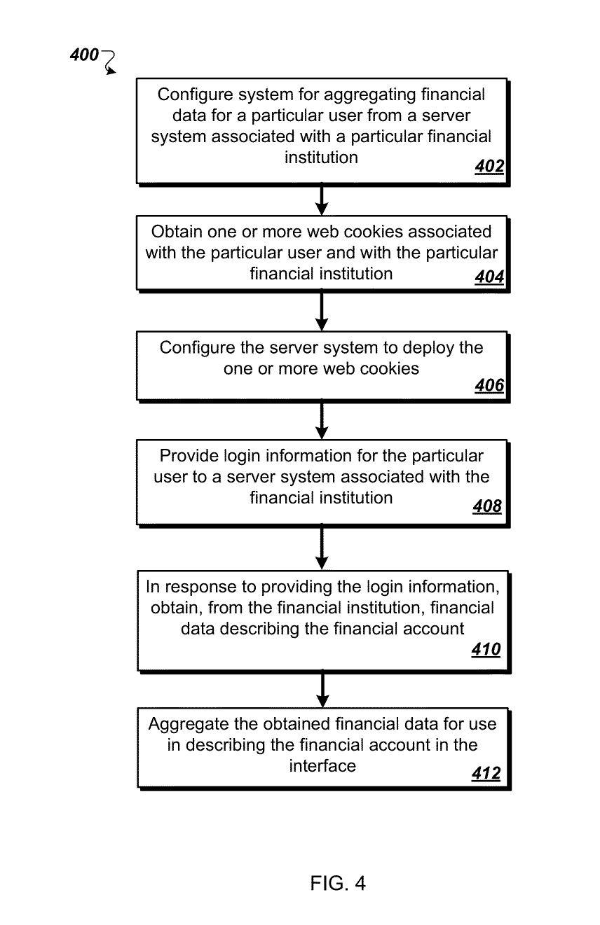

FIG. 4 illustrates an example method 400 for deploying stored web cookies. For convenience, the example method 400 will be described in reference to a system that performs the method 400. The system can be, for example, the aggregator server system 106, or the financial institution server system 112 or 114.

The system is instructed to aggregate financial data for a particular user from a server system that is associated with a particular financial institution (402). The system can receive instructions to aggregate financial data for a particular user, for example, based on a predetermined queue that indicates an aggregation order for users and their respective financial accounts associated with particular financial institutions.

The system obtains one or more web cookies that are associated with the particular user and with the particular financial institution (404). The system can obtain the one or more web cookies from a cookie list (e.g., XML file) that stores data describing the one or more web cookies, as described above. For example, the system can evaluate the cookie list to extract web cookies that are associated with the particular user and with the particular financial institution.

The system is configured to deploy the one or more obtained web cookies (406). In some implementations, when the one or more web cookies is a flash cookie, the system identifies a location that stores the obtained flash cookie based on the APPDATA environment variable. In particular, the system overwrites the APPDATA environment variable using, for example, the Microsoft Windows® Application Programming Interface (API). Since the system may be aggregating financial data for multiple users in parallel using multiple system processes, the system sets a distinct APPDATA environment variable for each system process so that each APPDATA environment variable points to a location that stores web cookies for a respective user and the user's corresponding financial institutions.

In situations where the web cookie is not a flash cookie, the system overwrites the cookies registry key value to identify a customized location at the registry location. The customized location stores the one or more obtained web cookies. Since the system may be aggregating financial data for multiple users in parallel using multiple system processes, the system overwrites the cookies registry key value to identify a customized location at the registry location for each system process so that each cookies registry key value points to a location that stores web cookies for a respective user and the user's corresponding financial institutions.

The system provides login information and the one or more web cookies for the particular user to a server system associated with the financial institution (step 408). As described above, when aggregating a user's financial account on a particular financial institution, the system can transmit the user's login credentials (e.g., username and password) to the particular financial institution's server system over a network, e.g., the network 108. The system also provides the one or more obtained web cookies that are associated with the particular user and the particular financial institution to the server system associated with the financial institution.

The server system evaluates the one or more provided web cookies to identify the system. Since, based on the one or more web cookies, the server system can determine the identity of the system, the server system will typically not present the system with challenge questions. Thus, by deploying web cookies, the system can bypass various security challenges, including, for example, MFA-based challenges, CAPTCHA images, hard device tokens, or any other type of generic authentication that would otherwise be presented by the server system.

In response to providing the login information and the one or more web cookies to the server system, the system obtains, from the server system, data describing the user's financial account for the financial institution, as described above (step 410). In some situations, the system receives, from the server system, data identifying the one or more challenge questions in response to providing the login information and the one or more web cookies to the server system. In such situations, the system can store the one or more challenge questions and can obtain respective answers to the one or more challenge questions from the user, as described above.

The system aggregates the obtained financial data for use in describing the financial account in an interface, as described above (step 412).

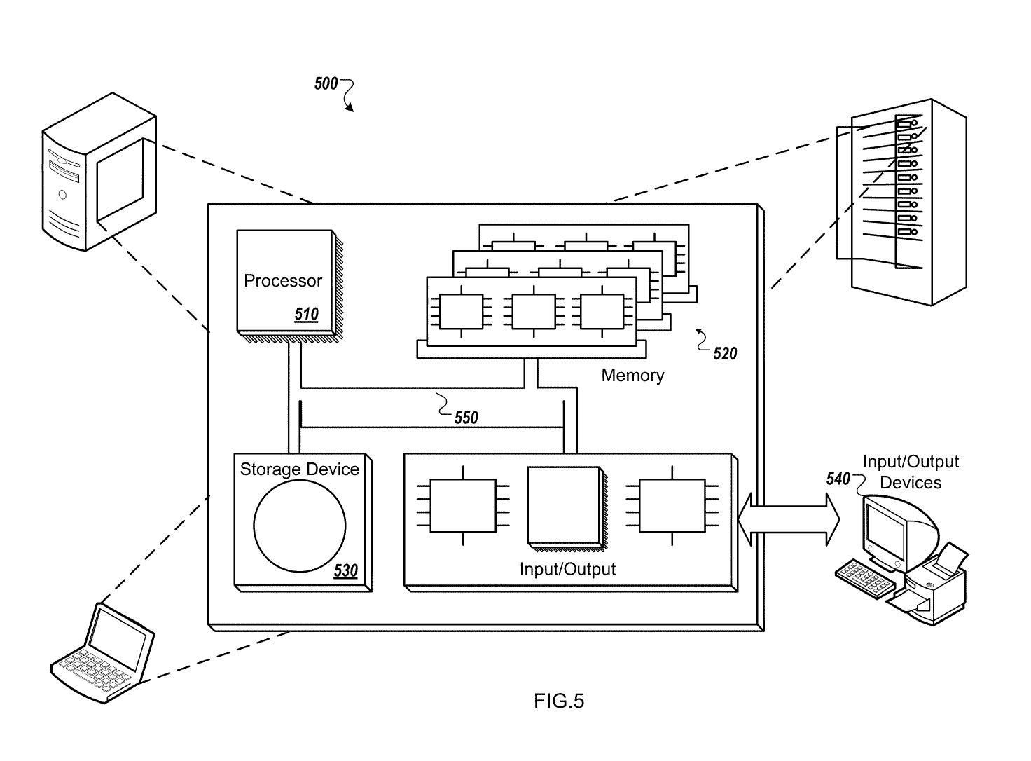

FIG. 5 is a schematic diagram of an example of a generic computer system 500. The system 500 can be used for the operations described above. For example, the system 500 may be included in either or all of the aggregator's server system 106, the financial institution server systems 112 and 114, or the user device 104.

The system 500 includes a processor 510, a memory 520, a storage device 530, and an input/output device 540. Instructions that implement operations associated with the methods described above can be stored in the memory 520 or on the storage device 530. Each of the components 510, 520, 530, and 540 are interconnected using a system bus 550. The processor 510 is capable of processing instructions for execution within the system 500. In some implementations, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In another implementation, the memory 520 is a non-volatile memory unit.

The storage device 530 is capable of providing mass storage for the system 500. In some implementations, the storage device 530 is a computer-readable medium. In various different implementations, the storage device 530 may be a floppy disk device, a hard disk device, an optical disk device, or a tape device.

The input/output device 540 provides input/output operations for the system 500. In some implementations, the input/output device 540 includes a keyboard and/or pointing device. In another implementation, the input/output device 540 includes a display unit for displaying graphical user interfaces.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions encoded on a computer storage medium for execution by, or to control the operation of, data processing apparatus. The computer storage medium can be a machine-readable storage device, a machine-readable storage substrate, a random or serial access memory device, or a combination of one or more of them. Alternatively or in addition to being encoded on a storage medium, the program instructions can be encoded on a propagated signal that is an artificially generated signal, e.g., a machine-generated electrical, optical, or electromagnetic signal, that is generated to encode information for transmission to suitable receiver apparatus for execution by a data processing apparatus.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving, from a user device, a request to include financial data describing a financial account in an interface, the financial account being associated with a particular financial institution;
obtaining login information for accessing the financial account;
providing the login information to a server system associated with the financial institution;
in response to providing the login information to the server system, receiving, from the server system, data identifying one or more challenge questions;
obtaining, from the user device, the respective answers for the one or more challenge questions; and
storing the one or more challenge questions and their respective answers for use in accessing and aggregating financial data describing the financial account.

2. The method of claim 1, further comprising:
providing the login information to a server system associated with the financial institution;
in response to providing the login information to the server system, receiving, from the server system, data identifying the one or more challenge questions;
providing, to the server system, the respective answers to the one or more challenge questions;
in response to providing the respective answers, obtaining, from the financial institution, financial data describing the financial account; and
aggregating the obtained financial data for use in describing the financial account in the interface.

3. The method of claim 1, wherein obtaining, from the user device, the respective answers for the one or more challenge questions comprises:
presenting, to the user device, an interface that identifies the one or more challenge questions; and
receiving, from the user device, respective answers to the one or more challenge questions.

4. The method of claim 1, wherein obtaining login information for accessing the financial account comprises:
presenting, to the user device, an interface requesting login credentials; and
receiving, from the user device, the login credentials.

5. The method of claim 1, wherein the one or more challenge questions includes a request for entering a one-time password that was transmitted from the server system to the user device.

6. The method of claim 1, further comprising:
obtaining, from the aggregator server system, data identifying a web cookie, wherein the web cookie identifies the aggregator server system to the server system, and wherein the web cookie was provided to the aggregator server system from the server system upon providing the login information to the server system; and
storing the data identifying the web cookie for use in accessing and aggregating financial data describing the financial account.

7. The method of claim 6, wherein the web cookie is configured to bypass one or more security challenges presented by the server system.

8. The method of claim 7, wherein the one or more security challenges include MFA-based challenges, CAPTCHA images, and hard device tokens.

9. The method of claim 6, further comprising:
providing, to the server system associated with the financial institution, the login information and the data identifying the web cookie;
in response to providing the login information and the data identifying the web cookie, obtaining, from the financial institution, financial data describing the financial account; and
aggregating the obtained financial data for use in describing the financial account in the interface.

10. The method of claim 1, wherein the challenge questions have respective answers that were previously provided to the server system by the user.

11. The method of claim 1, wherein at least one of the challenge questions have a respective answer that was generated by the server system, and wherein the respective answer was provided by the user using the user device through an interface provided by the aggregator server system.

12. The method of claim 1, further comprising:
obtaining, from the server system and from a web page associated with the financial account, data describing one or more second challenge questions that were not presented by the server system and respective answers to the one or more second challenge questions; and
storing the one or more second challenge questions and their respective answers for use in accessing and aggregating financial data describing the financial account.

13. A computer storage medium encoded with a computer program, the program comprising instructions that when executed by data processing apparatus cause the data processing apparatus to perform operations comprising:
receiving, from a user device, a request to include financial data describing a financial account in an interface, the financial account being associated with a particular financial institution;
obtaining login information for accessing the financial account;
providing the login information to a server system associated with the financial institution;
in response to providing the login information to the server system, receiving, from the server system, data identifying one or more challenge questions;
obtaining, from the user device, the respective answers for the one or more challenge questions; and
storing the one or more challenge questions and their respective answers for use in accessing and aggregating financial data describing the financial account.

14. The medium of claim 13, further comprising:
providing the login information to a server system associated with the financial institution;
in response to providing the login information to the server system, receiving, from the server system, data identifying the one or more challenge questions;
providing, to the server system, the respective answers to the one or more challenge questions;
in response to providing the respective answers, obtaining, from the financial institution, financial data describing the financial account; and
aggregating the obtained financial data for use in describing the financial account in the interface.

15. The medium of claim 13, wherein obtaining, from the user device, the respective answers for the one or more challenge questions comprises:
presenting, to the user device, an interface that identifies the one or more challenge questions; and
receiving, from the user device, respective answers to the one or more challenge questions.

16. The medium of claim 13, wherein obtaining login information for accessing the financial account comprises:
presenting, to the user device, an interface requesting login credentials; and
receiving, from the user device, the login credentials.

17. The medium of claim 13, wherein the one or more challenge questions includes a request for entering a one-time password that was transmitted from the server system to the user device.

18. The medium of claim 13, further comprising:
obtaining, from the aggregator server system, data identifying a web cookie, wherein the web cookie identifies the aggregator server system to the server system, and wherein the web cookie was provided to the aggregator server system from the server system upon providing the login information to the server system; and
storing the data identifying the web cookie for use in accessing and aggregating financial data describing the financial account.

19. The medium of claim 18, wherein the web cookie is configured to bypass one or more security challenges presented by the server system.

20. The medium of claim 19, wherein the one or more security challenges include MFA-based challenges, CAPTCHA images, and hard device tokens.

21. The medium of claim 18, further comprising:
providing, to the server system associated with the financial institution, the login information and the data identifying the web cookie;
in response to providing the login information and the data identifying the web cookie, obtaining, from the financial institution, financial data describing the financial account; and
aggregating the obtained financial data for use in describing the financial account in the interface.

22. The medium of claim 13, wherein the challenge questions have respective answers that were previously provided to the server system by the user.

23. The medium of claim 13, wherein at least one of the challenge questions have a respective answer that was generated by the server system, and wherein the respective answer was provided by the user using the user device through an interface provided by the aggregator server system.

24. The medium of claim 13, further comprising:
obtaining, from the server system and from a web page associated with the financial account, data describing one or more second challenge questions that were not presented by the server system and respective answers to the one or more second challenge questions; and
storing the one or more second challenge questions and their respective answers for use in accessing and aggregating financial data describing the financial account.

25. A system comprising one or more computers programmed to perform operations comprising:
receiving, from a user device, a request to include financial data describing a financial account in an interface, the financial account being associated with a particular financial institution;
obtaining login information for accessing the financial account;
providing the login information to a server system associated with the financial institution;
in response to providing the login information to the server system, receiving, from the server system, data identifying one or more challenge questions;
obtaining, from the user device, the respective answers for the one or more challenge questions; and
storing the one or more challenge questions and their respective answers for use in accessing and aggregating financial data describing the financial account.

26. The system of claim 25, further comprising:
providing the login information to a server system associated with the financial institution;
in response to providing the login information to the server system, receiving, from the server system, data identifying the one or more challenge questions;
providing, to the server system, the respective answers to the one or more challenge questions;
in response to providing the respective answers, obtaining, from the financial institution, financial data describing the financial account; and
aggregating the obtained financial data for use in describing the financial account in the interface.

27. The system of claim 25, wherein obtaining, from the user device, the respective answers for the one or more challenge questions comprises:
presenting, to the user device, an interface that identifies the one or more challenge questions; and
receiving, from the user device, respective answers to the one or more challenge questions.

28. The system of claim 25, wherein obtaining login information for accessing the financial account comprises:
presenting, to the user device, an interface requesting login credentials; and
receiving, from the user device, the login credentials.

29. The system of claim 25, wherein the one or more challenge questions includes a request for entering a one-time password that was transmitted from the server system to the user device.

30. The system of claim 25, further comprising:
obtaining, from the aggregator server system, data identifying a web cookie, wherein the web cookie identifies the aggregator server system to the server system, and wherein the web cookie was provided to the aggregator server system from the server system upon providing the login information to the server system; and
storing the data identifying the web cookie for use in accessing and aggregating financial data describing the financial account.

31. The system of claim 30, wherein the web cookie is configured to bypass one or more security challenges presented by the server system.

32. The system of claim 31, wherein the one or more security challenges include MFA-based challenges, CAPTCHA images, and hard device tokens.

33. The system of claim 30, further comprising:
providing, to the server system associated with the financial institution, the login information and the data identifying the web cookie;
in response to providing the login information and the data identifying the web cookie, obtaining, from the financial institution, financial data describing the financial account; and
aggregating the obtained financial data for use in describing the financial account in the interface.

34. The system of claim 25, wherein the challenge questions have respective answers that were previously provided to the server system by the user.

35. The system of claim 25, wherein at least one of the challenge questions have a respective answer that was generated by the server system, and wherein the respective answer was provided by the user using the user device through an interface provided by the aggregator server system.

36. The system of claim 25, further comprising:
obtaining, from the server system and from a web page associated with the financial account, data describing one or more second challenge questions that were not presented by the server system and respective answers to the one or more second challenge questions; and
storing the one or more second challenge questions and their respective answers for use in accessing and aggregating financial data describing the financial account.
